(19) United States
(12) Patent Application Publication
(10) Pub. No.: US 2014/0139758 A1
(43) Pub. Date: May 22, 2014

(54) TOUCH PANEL AND TOUCH DISPLAY MODULE THEREOF

(71) Applicant: WINTEK CORPORATION, Taichung City (TW)

(72) Inventors: Ming-Sin Jian, Taichung City (TW); Kuo-Chang Su, Taichung City (TW); Chih-Jung Teng, Taichung City (TW)

(73) Assignee: WINTEK CORPORATION, Taichung City (TW)

(21) Appl. No.: 14/086,994

(22) Filed: Nov. 22, 2013

(30) Foreign Application Priority Data
Nov. 22, 2012 (TW) 101143679

(51) Int. Cl. G06F 3/041

(52) U.S. Cl. CPC G06F 3/0412
USPC 349/12

(57) ABSTRACT

A touch panel including a transparent cover plate, a decorative layer, and a touch layer structure is provided. The transparent cover plate has a viewing area and at least one side bending portion. The decorative layer is formed at a position at least corresponding to the side bending portion. The touch layer structure includes a touch sensing layer and a plurality of conductive traces. The touch sensing layer is disposed at a position corresponding to the viewing area. The plurality of conductive traces is electrically connected to the touch sensing layer and disposed at a position corresponding to the decorative layer.

### BACKGROUND OF THE INVENTION

1. Field of the Invention

The present invention relates to a touch panel and a touch display module thereof, and more specifically, to a touch panel of disposing conductive traces on a decorative layer located on a side bending portion of a transparent cover plate and a touch display module thereof.

2. Description of the Prior Art

In general, a touch display module (e.g. a smart phone) usually adopts the design that conductive traces are disposed on a border area, which is coated with a decorative layer, of a transparent cover plate to be electrically connected to a touch sensing layer and a flexible circuit board, so as to achieve the trace covering purpose.

However, number of the conductive traces accordingly increases as the circuit design of the touch sensing layer becomes more and more complicated, so as to cause the problem that space provided by the border area of the transparent cover plate is not enough to contain the numerous conductive traces.

Although the aforesaid problem could be solved by enlarging the border area of the transparent cover plate, it is disadvantageous to the narrow border design of the touch display module. Therefore, how to increase the containing space for the conductive traces and narrow the border area of the transparent cover plate simultaneously is a major concern to the structural design of the touch display module.

### SUMMARY OF THE INVENTION

The present invention provides a touch panel including a transparent cover plate, a decorative layer, and a touch layer structure. The transparent cover plate has a viewing area and at least one side bending portion. The decorative layer is formed at a position at least corresponding to the at least one side bending portion. The touch layer structure includes a touch sensing layer and a plurality of conductive traces. The touch sensing layer is disposed at a position corresponding to the viewing area. The plurality of conductive traces is electrically connected to the touch sensing layer and disposed at a position corresponding to the decorative layer.

The present invention further provides a touch display module including a host device, a display panel, and a touch panel. The display panel is disposed on the host device. The touch panel is disposed on the display panel and includes a transparent cover plate, a decorative layer, and a touch layer structure. The transparent cover plate has a viewing area and at least one side bending portion. The decorative layer is formed at a position at least corresponding to the at least one side bending portion. The touch layer structure includes a touch sensing layer and a plurality of conductive traces. The touch sensing layer is disposed at a position corresponding to the viewing area. The plurality of conductive traces is electrically connected to the touch sensing layer and disposed at a position corresponding to the decorative layer.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a touch display module according to a first embodiment of the present invention.

FIG. 2 is a partial sectional diagram of the touch display module in FIG. 1 along a sectional line A-A′.

FIG. 3 is an exploded diagram of a touch panel according to a second embodiment of the present invention.

FIG. 4 is an exploded diagram of a touch panel according to a third embodiment of the present invention.

FIG. 5 is an exploded diagram of a touch panel according to a fourth embodiment of the present invention.

FIG. 6 is an exploded diagram of a touch panel according to a fifth embodiment of the present invention.

FIG. 7 is a partial sectional diagram of a touch display module according to a sixth embodiment of the present invention.

FIG. 8 is a partial sectional diagram of a touch display module according to a seventh embodiment of the present invention.

FIG. 9 is a partial sectional diagram of a touch display module according to an eighth embodiment of the present invention.

FIG. 10 is a partial sectional diagram of a touch display module according to a ninth embodiment of the present invention.

FIG. 11 is a top view of a touch sensing layer according to a tenth embodiment of the present invention.

FIG. 12 is a partial sectional diagram of the touch sensing layer in FIG. 11 along a sectional line B-B′.

FIG. 13 is a partial sectional diagram of a touch layer structure according to an eleventh embodiment of the present invention.

### DETAILED DESCRIPTION

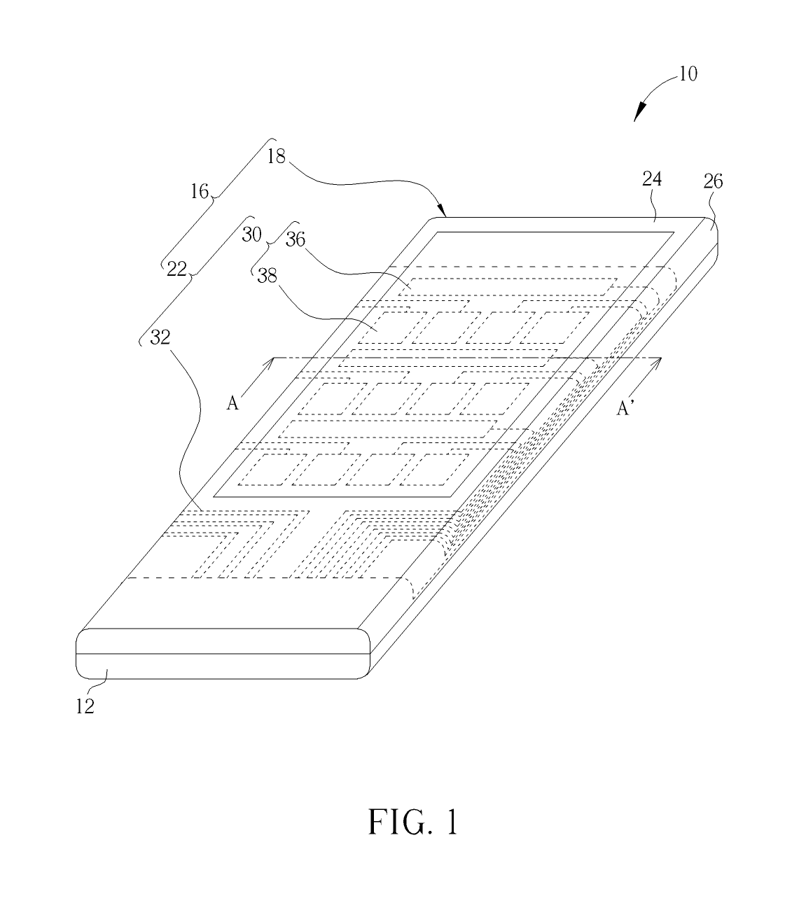

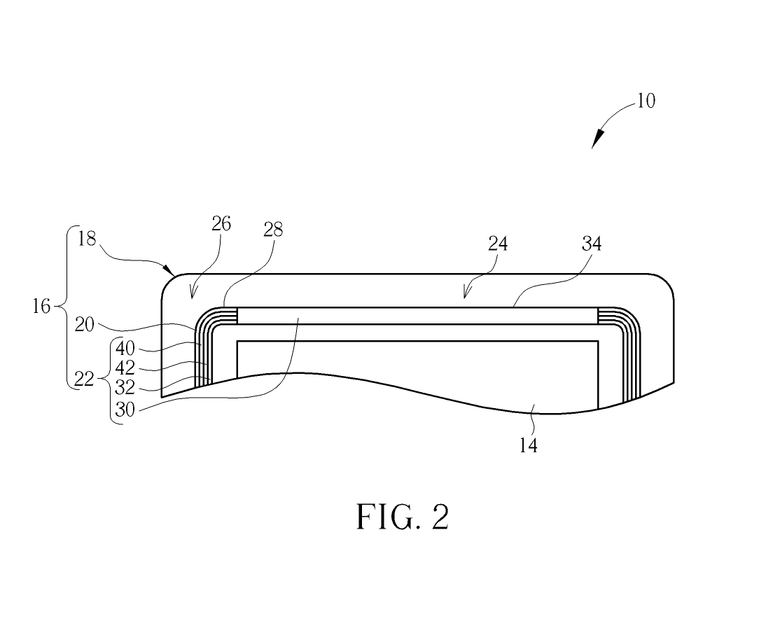

Please refer to FIG. 1 and FIG. 2. FIG. 1 is a diagram of a touch display module 10 according to a first embodiment of the present invention. FIG. 2 is a partial sectional diagram of the touch display module 10 in FIG. 1 along a sectional line A-A′. As shown in FIG. 1 and FIG. 2, the touch display module 10 includes a host device 12, a display panel 14, and a touch panel 16. The display panel 14 is disposed on the host device 12. In this embodiment, the display panel 14 could be a conventional display device (e.g. a liquid crystal display device, an OLED (Organic Light Emitting Diode) display device, an electro-wetting display device, or an electro-phoretic display device). The host device 12 could include host components (e.g. a central processing unit and a motherboard) installed in a conventional touch display device (e.g. a smart phone), and the related description is therefore omitted herein since it is commonly seen in the prior art.

As shown in FIG. 2, the touch panel 16 is disposed on the display panel 14 for a user to perform touch operations. The touch panel 16 includes a transparent cover plate 18, a decorative layer 20, and a touch layer structure 22. The transparent cover plate 18 has a planar surface portion 24 and at least one side bending portion 26 (two shown in FIG. 2, but not limited thereto). The features of transparent cover plate 18 include high mechanical strength, capability of scratch resistant and function of decoration. The transparent cover plate 18 can be made of glass, plastic or the composite thereof. The glass can be strengthened glass by chemical or physical process. The transparent cover plate 18 includes a thickness between 0.2-2 mm with optical function thin film thereon such as anti-reflection film and the light transmission rate is above 85%. The planar surface portion 24 is a viewing area, and the side bending portion 26 is a non-viewing area. In other embodiment, the viewing area could be a curved surface area instead of a planar surface area. The decorative layer 20 is formed at a position corresponding to an inner surface 28 of the side bending portion 26. In this embodiment, the decorative layer 20 could be made of at least one of ceramics, diamond-like carbon, printing ink, photo-resistance, and resin material and could be directly formed on the inner surface 28 of the side bending portion 26. Accordingly, the touch display module 10 could utilize the decorative layer 20 to decorate the outer appearance of the touch display module 10 and cover inner traces of the touch display module 10.

The touch layer structure 22 includes a touch sensing layer 30 and a plurality of conductive traces 32. The touch sensing layer 30 is disposed at a position corresponding to an inner surface 34 of the planar surface portion 24. In this embodiment, as shown in FIG. 1 and FIG. 2, the touch sensing layer 30 could include a plurality of stripe induction electrodes 36 and a plurality of block induction electrodes 38. The touch sensing layer 30 could be directly formed on the inner surface 34 of the planar surface portion 24. To be more specific, the plurality of stripe induction electrodes 36 is alternately formed on the inner surface 34 of the planar surface portion 24 and each block induction electrode 38 is formed on a position located between two adjacent stripe induction electrodes 36, so as to achieve the purpose that planar positioning of the touch layer structure 22 could be performed according to capacitance effect variation between the stripe induction electrode 36 and the block induction electrode 38.

In other embodiment, the touch sensing layer 30 is made of ITO (Indium Tin Oxide), metal material or the composite thereof, and could be patterned in the form of meshes. The above metal material may include at least one among silver (Ag), aluminum (Al), copper (Cu), chromium (Cr), titanium (Ti), molybdenum (Mo), an alloy thereof, a composite layer thereof, or a composite layer of the above-mentioned materials and alloys. For example, a composite layer can be three layers stack structure such as Mo/Al/Mo or ITO/Ag/ITO structure.

The plurality of conductive traces 32 is electrically connected to the touch sensing layer 30 and disposed at a position corresponding to the decorative layer 20. To be more specific, in this embodiment, each conductive trace 32 is made of ITO (Indium Tin Oxide) or metal material and formed on the decorative layer 20 for achieving the trace covering purpose. Each conductive trace 32 is further coupled to the corresponding induction electrode (i.e. the stripe induction electrode 36 or the block induction electrode 38) for signal transmission. In other embodiments, the touch sensing layer 30 could be partially overlapped and directly contacted with the decorative layer 20.

Furthermore, since the conductive traces 32 are disposed on the side bending portion 26, signal transmission of the conductive traces 32 could be interfered when a user holds a side of the touch display module 10 with his hand. Thus, in the design that the decorative layer 20 is made of non-metal material (e.g. printing ink, photo-resistance or resin material), as shown in FIG. 2, the touch panel 16 could further include a conductive shield layer 40 and an insulation layer 42. The conductive shield layer 40 is disposed on the decorative layer 20. The insulation layer 42 is disposed between the conductive shield layer 40 and the plurality of conductive traces 32 for preventing the conductive shield layer 40 from contacting with the conductive traces 32. Accordingly, the touch panel 16 could utilize the conductive shield layer 40 to generate the conductive shielding effect for solving the aforesaid signal interference problem, so that the signal transmission quality of the conductive traces 32 could be further improved. To be noted, if the decorative layer 20 is made of metal material (e.g. nano-silver material), disposal of the conductive shield layer 40 could be omitted since the touch panel 16 could directly utilize the decorative layer 20 as a conductive shield layer to generate the conductive shielding effect.

Via the design that the transparent cover plate 18 has a side bending portion 26, the decorative layer 20 is disposed on the side bending portion 26, and the conductive traces 32 are disposed on the decorative layer 20, the touch display module 10 could utilize the side bending portion 26 to provide additional space for disposal of the conductive traces 32. In such a manner, the present invention could efficiently solve the prior art problem that space provided by the border area of the transparent cover plate is not enough to contain the numerous conductive traces. Furthermore, since disposal of the conductive traces 32 does not occupy space of the planar surface portion 24 of the transparent cover plate 18, the present invention could further narrow the border area of the touch display module 10 so as to be advantageous to the narrow border design of the touch display module 10.

The design for the touch layer structure of the present invention is not limited to the first embodiment. The present invention could also utilize the design that the touch sensing layer is formed on a flexible film. Furthermore, the present invention could adopt other conventional electrode configuration and electrode pattern (e.g. rhombus or triangle) designs instead of the aforesaid designs mentioned in the first embodiment. In other words, all designs of disposing the decorative layer and the conductive traces of the touch layer structure at a position corresponding to the side bending portion of the transparent plate would fall within the scope of the present invention.

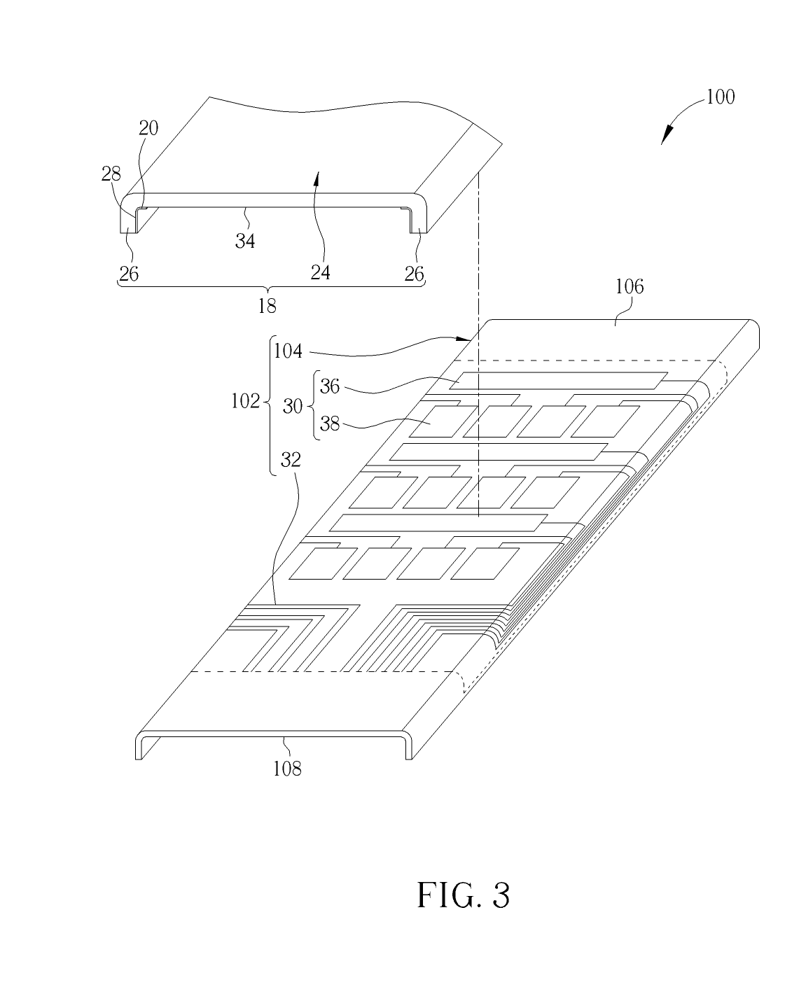

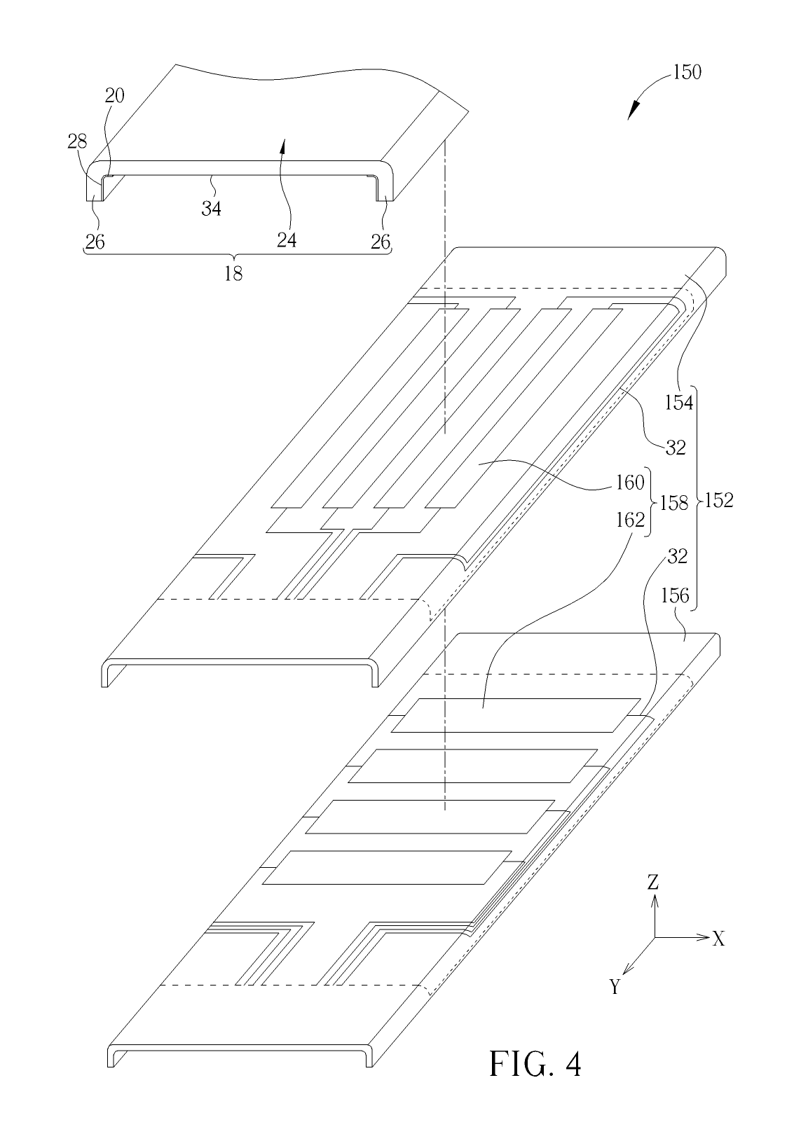

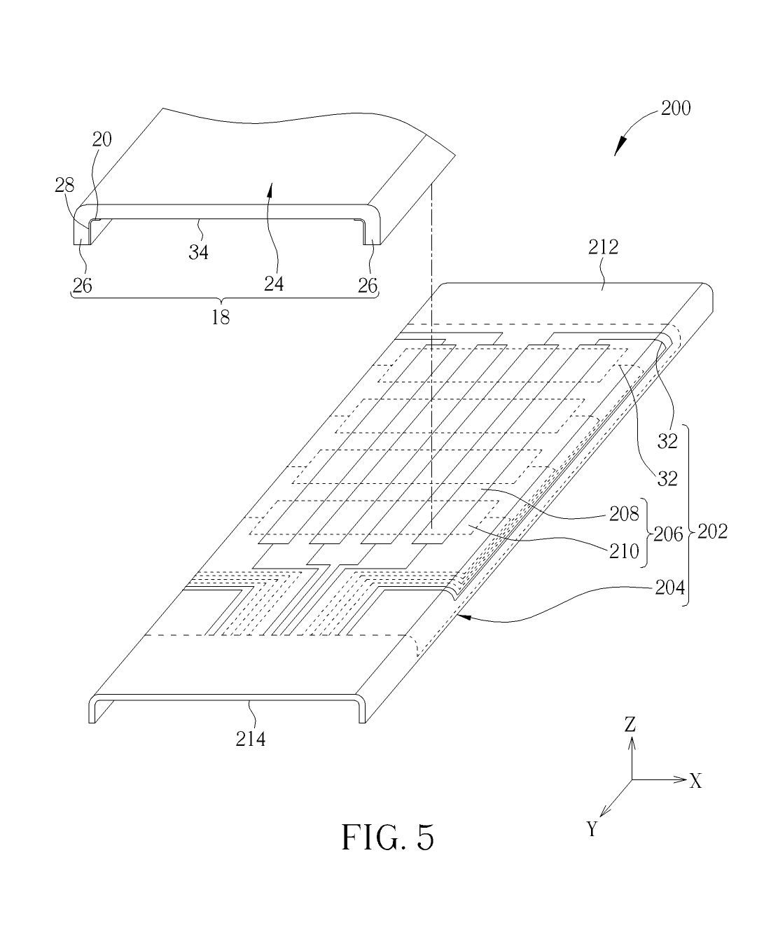

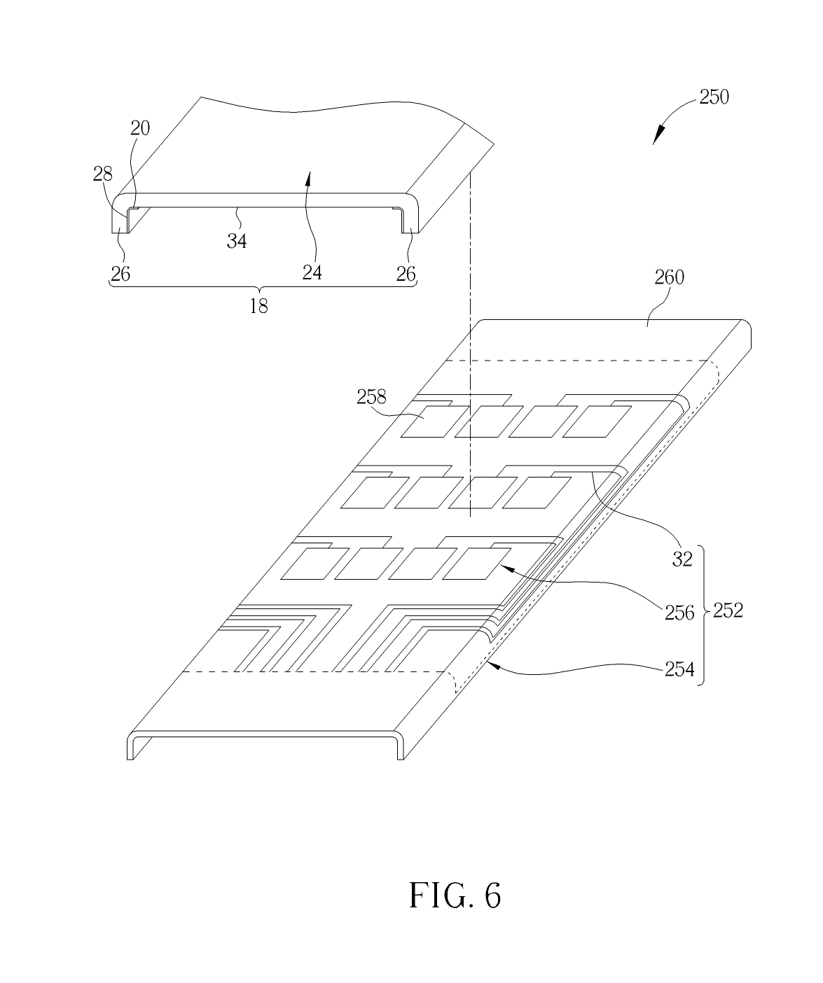

For example, please refer to FIG. 3, FIG. 4, FIG. 5, and FIG. 6. FIG. 3 is an exploded diagram of a touch panel 100 according to a second embodiment of the present invention. FIG. 4 is an exploded diagram of a touch panel 150 according to a third embodiment of the present invention. FIG. 5 is an exploded diagram of a touch panel 200 according to a fourth embodiment of the present invention. FIG. 6 is an exploded diagram of a touch panel 250 according to a fifth embodiment of the present invention. More detailed description is provided as follows.

Please refer to FIG. 3. In the second embodiment, the touch panel 100 includes the transparent cover plate 18, the decorative layer 20, and a touch layer structure 102, and the touch layer structure 102 includes the touch sensing layer 30, the plurality of conductive traces 32, and a flexible film 104. The touch sensing layer 30 and the plurality of conductive traces 32 are formed on the flexible film 104. That is, the plurality of stripe induction electrodes 36 is alternately formed on an outer surface 106 of the flexible film 104 and arranged along a first axial direction, each block induction electrode 38 is formed on a position located between two adjacent stripe induction electrodes 36 and arranged along the first axial direction, and the plurality of conductive traces 32 is formed on the outer surface 106 of the flexible film 104 and extended from the plurality of stripe induction electrodes 36 and the plurality of block induction electrodes 38 to the position corresponding to the decorative layer 20 along the first axial direction. In other embodiment, the plurality of stripe induction electrodes 36 and the plurality of block induction electrodes 38 can respectively comprise branch parts. Moreover, the plurality of conductive traces 32 is extended from the position corresponding to the decorative layer 20 to the position corresponding to the planar surface portion 24 for electrically connected with an external circuit board, such as a flexible printed circuit (FPC).

Via the aforesaid configuration, assembly of the touch panel 100 could be accordingly completed after the flexible film 104 is attached to the side bending portion 26 and the inner surface 34 of the planar surface portion 24 along the contour of the transparent cover plate 18.

Please refer to FIG. 4. The major difference between the touch panel 150 in the third embodiment and the touch panel 100 in the second embodiment is the design of the touch layer structure. In this embodiment, the touch panel 150 includes the transparent cover plate 18, the decorative layer 20, and a touch layer structure 152. The touch layer structure 152 includes the plurality of conductive traces 32, a first flexible film 154, a second flexible film 156, and a touch sensing layer 158. The touch sensing layer 158 includes a plurality of first induction electrodes 160 and a plurality of second induction electrodes 162 wherein the average width of each second induction electrode 162 is wider than the average width of each first induction electrode 160 to provide shielding effect such that the capacitive coupling between the first induction electrodes 160 and the display panel 14 can be prevented. Moreover, the wider second induction electrodes 162 provide a uniform appearance. The first induction electrodes 160 are sensing electrodes and the second induction electrodes 162 are driving electrodes wherein the impedance of each first induction electrode 160 is smaller than that of each second induction electrode 162. The plurality of first induction electrodes 160 is alternately formed on the first flexible film 154 along a first axial direction (i.e. the Y-axis direction as shown in FIG. 4). The plurality of second induction electrodes 162 is alternately formed on the second flexible film 156 along a second axial direction (i.e. the X-axis direction as shown in FIG. 4). The conductive traces 32 electrically connected to the plurality of first induction electrodes 160 are formed on the first flexible film 154 corresponding to the decorative layer 20, and the conductive traces 32 electrically connected to the plurality of second induction electrodes 162 are formed on the second flexible film 156 corresponding to the decorative layer 20 wherein the conductive traces 32 electrically connected to the plurality of first induction electrodes 160 are not overlapped with the conductive traces 32 electrically connected to the plurality of second induction electrodes 162 to prevent signal interference. In other embodiment, the touch sensing layer 158 could be partially overlapped with the decorative layer 20.

In addition, the first induction electrodes 160 and the second induction electrodes 162 made of ITO have higher impedance on the flexible film, so the conductive traces 32 are designed for respectively connecting with two ends of each first induction electrode 160 and each second induction electrode 162 to reduce the impedance of the first induction electrodes 160 on the first flexible film 154 and the second induction electrodes 162 on the second flexible film 156. In other embodiments, the conductive traces 32 could be respectively connected with one end of each first induction electrode 160 and each second induction electrode 162.

Via the aforesaid configuration, assembly of the touch panel 150 could be accordingly completed after the first flexible film 154 and the second flexible film 156 are sequentially attached to the decorative layer 20 and the inner surface 34 of the planar surface portion 24 along the contour of the transparent cover plate 18.

Please refer to FIG. 5. Components both mentioned in the fourth embodiment and the second embodiment represent components with similar function or structures, and the related description is omitted herein. The major difference between the touch panel 200 in the fourth embodiment and the touch panel 100 in the second embodiment is the design of the touch layer structure. In this embodiment, the touch panel 200 includes the transparent cover plate 18, the decorative layer 20, and a touch layer structure 202. The touch layer structure 202 includes the plurality of conductive traces 32, a flexible film 204, and a touch sensing layer 206. The touch sensing layer 206 includes a plurality of first induction electrodes 208 and a plurality of second induction electrodes 210 wherein the average width of each second induction electrode 210 is wider than the average width of each first induction electrode 208 to provide shielding effect such that the capacitive coupling between the first induction electrodes 208 and the display panel 14 can be prevented. Moreover, the wider second induction electrodes 210 provide a uniform appearance. The plurality of first induction electrodes 208 is alternately formed on an outer surface 212 of the flexible film 204 along the first axial direction (i.e. the Y-axis direction as shown in FIG. 5). The plurality of second induction electrodes 210 is alternately formed on an inner surface 214 of the flexible film 204 along the second axial direction (i.e. the X-axis direction as shown in FIG. 5). The conductive traces electrically connected to the plurality of first induction electrodes 208 are formed on the outer surface 212 of the flexible film 204 corresponding to the decorative layer 20, and the conductive traces 32 electrically connected to the plurality of second induction electrodes 210 are formed on the inner surface 214 of the flexible film 204 corresponding to the decorative layer 20 wherein the conductive traces 32 electrically connected to the plurality of first induction electrodes 208 are not overlapped with the conductive traces 32 electrically connected to the plurality of second induction electrodes 210 to prevent signal interference. In other embodiment, the touch sensing layer 206 could be partially overlapped with the decorative layer 20.

In addition, the first induction electrodes 208 and the second induction electrodes 210 made of ITO have higher impedance on the flexible film, so the conductive traces 32 are designed for respectively connecting with two ends of each first induction electrode 208 and each second induction electrode 210 to reduce the impedance of the first induction electrodes 208 and the second induction electrodes 210 on the flexible film 204. In other embodiments, the conductive traces 32 could be respectively connected with one end of each first induction electrode 208 and each second induction electrode 210.

Via the aforesaid configuration, assembly of the touch panel 200 could be accordingly completed after the flexible film 204 is attached to the decorative layer 20 and the inner surface 34 of the planar surface portion 24 along the contour of the transparent cover plate 18.

Please refer to FIG. 6. The major difference between the touch panel 250 in the fifth embodiment and the touch panel 100 in the second embodiment is the design of the touch layer structure. In this embodiment, the touch panel 250 includes the transparent cover plate 18, the decorative layer 20, and a touch layer structure 252. The touch layer structure 252 includes the plurality of conductive traces 32, a flexible film 254, and a touch sensing layer 256. The touch sensing layer 256 includes a plurality of block induction electrodes 258. The plurality of block induction electrodes 258 is alternately formed on the flexible film 254 corresponding to the inner surface 34 of the planar surface portion 24, and the plurality of conductive traces 32 is correspondingly formed on an outer surface 260 of the flexible film 254 corresponding to the decorative layer 20. Moreover, the plurality of conductive traces 32 is extended from the position corresponding to the decorative layer 20 to the position corresponding to the planar surface portion 24 for electrically connected with an external circuit board, such as a flexible printed circuit (FPC).

Via the aforesaid configuration, assembly of the touch panel 250 could be accordingly completed after the flexible film 254 is attached to the decorative layer 20 and the inner surface 34 of the planar surface portion 24 along the contour of the transparent cover plate 18.

To be noted, in the second embodiment, the touch sensing layer 30 and the plurality of conductive traces 32 could be formed on an inner surface 108 of the flexible film 104 instead, and the decorative layer 20 could be correspondingly formed on the outer surface 106 of the flexible film 104 without directly contacted with the touch sensing layer 30 for covering the plurality of conductive traces 32. The aforesaid design could be also applied to the third embodiment, and the decorative layer could be correspondingly formed on the outer surface of the first flexible film instead. The related configuration could be reasoned according to the aforesaid description and therefore omitted herein. Furthermore, in the fourth embodiment, the decorative layer 20 is not limited to be formed on the inner surface 28 of the side bending portion 26 as shown in FIG. 2, meaning that the decorative layer 20 in the fourth embodiment could be independently formed on an additional flexible film to cooperatively form a decoration film. In such a manner, the aforesaid decoration film could be disposed between the transparent cover plate 18 and the flexible film 204 through an adhesive layer for covering the plurality of conductive traces 32 without directly contacted with the touch sensing layer 206. Furthermore, in the fifth embodiment, the decorative layer 20 is not limited to be formed on the inner surface 28 of the side bending portion 26 as shown in FIG. 2, meaning that the decorative layer 20 of the fifth embodiment could be formed on the outer surface 260 of the flexible film 254 for covering the plurality of conductive traces 32. Furthermore, the design that the induction electrodes and the conductive traces could be formed on the inner surface of the flexible film instead mentioned in the second embodiment could be also applied to the fifth embodiment, and the decorative layer could be correspondingly formed on the outer surface of the flexible film instead. The related configuration could be reasoned according to the aforesaid description and therefore omitted herein.

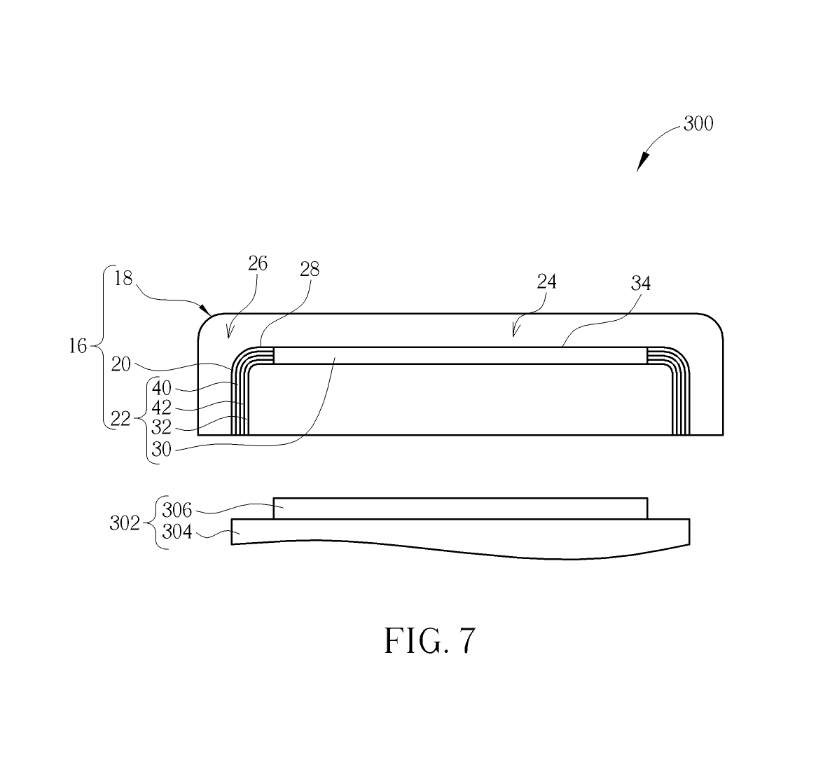

Furthermore, in the present invention, the transparent cover plate having the decorative layer and the touch layer structure disposed thereon could be directly used as an upper package cover of the display panel. For example, please refer to FIG. 7, which is a partial sectional diagram of a touch display module 300 according to a sixth embodiment of the present invention. Components both mentioned in the sixth embodiment and the first embodiment represent components with similar function or structures, and the related description is omitted herein. The major difference between the touch display module 300 in the sixth embodiment and the touch display module 10 in the first embodiment is the design of the display panel. The touch display module 300 includes the host device 12 (not shown in FIG. 7 for simplicity), the touch panel 16, and a display panel 302. The display panel 302 includes a bottom board 304 and a display layer 306. The display layer 306 is disposed on the bottom board 304. The display layer 306 could be the major display component (e.g. an OLED layer or an LED (Organic Light Emitting Diode) layer) for displaying images in a conventional display panel. The transparent cover plate 18 is used for containing the display layer 306 cooperatively with the bottom board 304. Accordingly, the present invention could further reduce the space occupied by the display panel in the touch display module, so as to be advantageous to the thinning design of the touch display module.

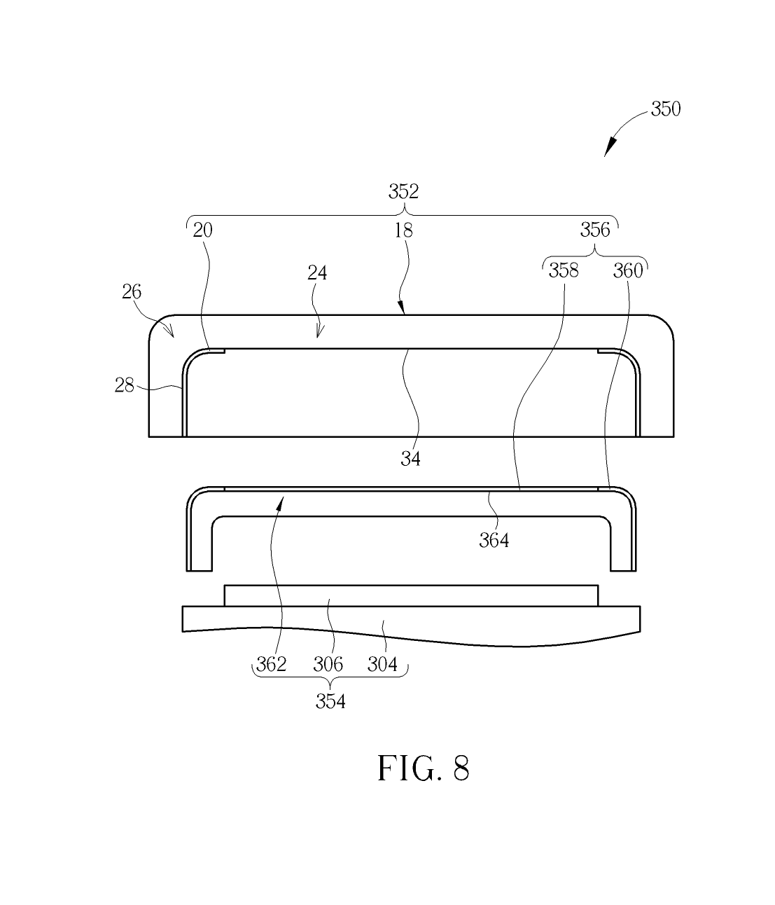

In other embodiment, an upper package cover of the display panel could be used as a holding board of the touch layer structure. For example, please refer to FIG. 8, which is a partial sectional diagram of a touch display module 350 according to a seventh embodiment of the present invention. Components both mentioned in the seventh embodiment and the sixth embodiment represent components with similar function or structures, and the related description is omitted herein. The major difference between the touch display module 350 in the seventh embodiment and the touch display module 300 in the sixth embodiment is the design of the touch layer structure and the design of the display panel. The touch display module 350 includes the host device 12 (not shown in FIG. 8 for simplicity), a touch panel 352, and a display panel 354. The touch panel 352 includes the transparent cover plate 18, the decorative layer 20, and a touch layer structure 356. The touch layer structure 356 includes a touch sensing layer 358 and a plurality of conductive traces 360. The display panel 354 includes an upper cover 362, the display layer 306, and the bottom board 304. The upper cover 362 could be used for packaging the display layer 306 cooperatively with the bottom board 304. Compared with the sixth embodiment, the seventh embodiment adopts the design that the touch sensing layer 358 is formed on an outer surface 364 of the upper cover 362 and the plurality of conductive traces 360 is formed on the outer surface 364 of the upper cover 362 corresponding to the decorative layer 20 instead. As for the electrode configuration adopted by the touch sensing layer 358, it could be reasoned according to the aforesaid embodiments, such as arrangement of the stripe induction electrodes and the block induction electrodes mentioned in the second embodiment or arrangement of the block induction electrodes mentioned in the fifth embodiment.

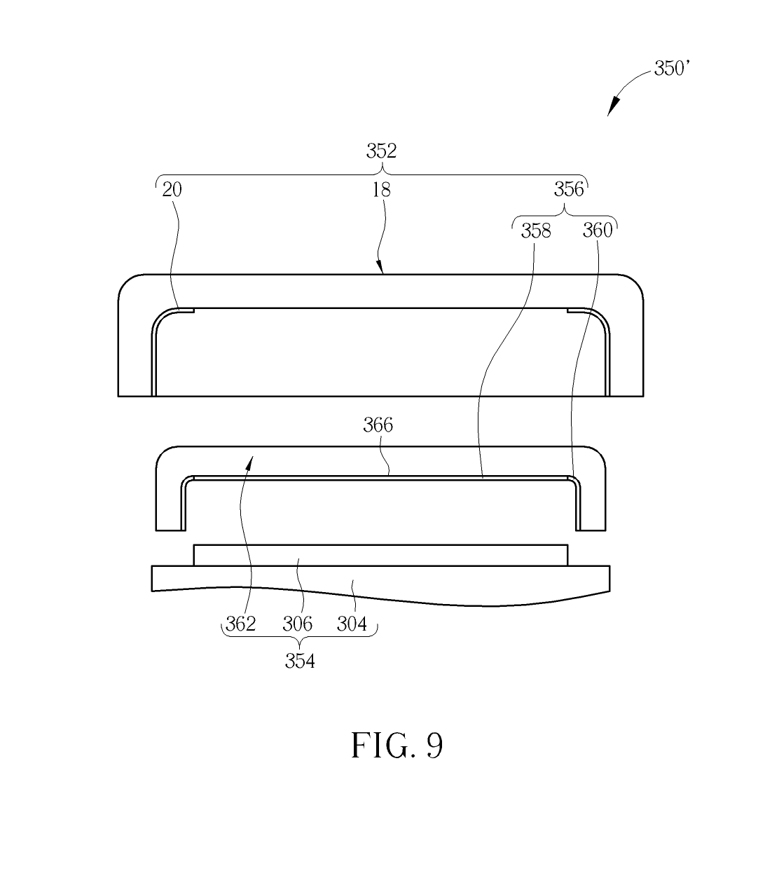

Via the aforesaid configuration, assembly of the touch panel 352 and the display panel 354 could be accordingly completed after the upper cover 362 packages the display layer 306 cooperatively with the bottom board 304 and then the upper cover 362 is attached to the decorative layer 20 and the inner surface 34 of the planar surface portion 24. To be noted, the touch sensing layer 358 and the plurality of conductive traces 360 could be formed on an inner surface 366 of the upper cover 362 instead, and the related configuration could be as shown in FIG. 9, which is a partial sectional diagram of a touch display module 350′ according to an eighth embodiment of the present invention.

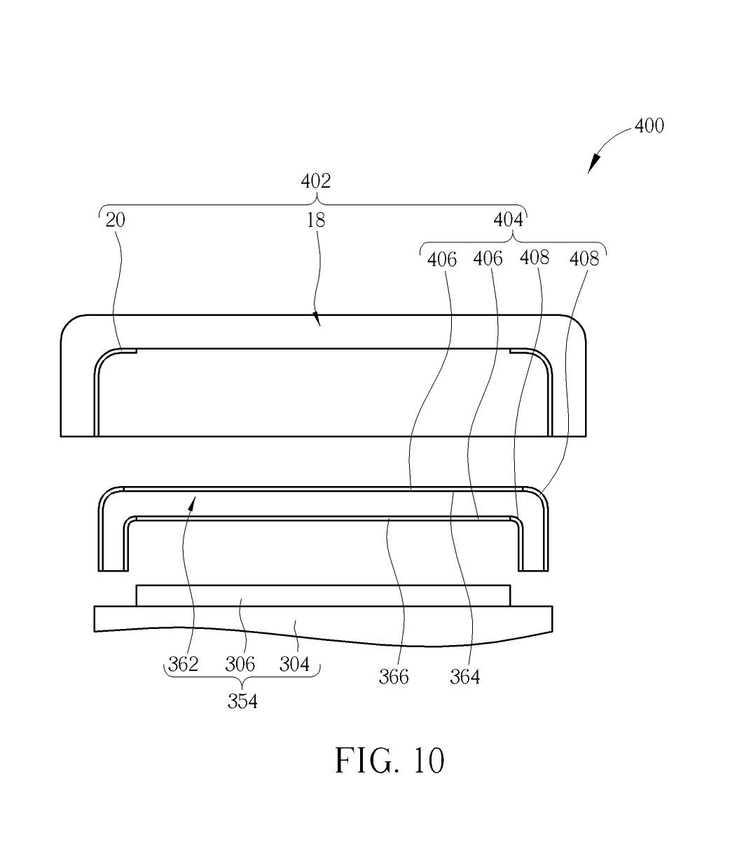

Furthermore, the design that the induction electrodes could be formed on the outer surface and the inner surface of the flexible film respectively mentioned in the fourth embodiment could be also applied to the seventh embodiment. Please refer to FIG. 10, which is a partial sectional diagram of a touch display module 400 according to a ninth embodiment of the present invention. Components both mentioned in the ninth embodiment and the seventh embodiment represent components with similar function or structures, and the related description is omitted herein. The major difference between the touch display module 400 and the touch display module 350 is the configuration of the touch layer structure and the plurality of conductive traces. The touch display module 400 includes the host device 12 (not shown in FIG. 10 for simplicity), a touch panel 402, and the display panel 354. The touch panel 402 includes the transparent cover plate 18, the decorative layer 20, and a touch layer structure 404. The touch layer structure 404 includes a touch sensing layer 406 and a plurality of conductive traces 408. In this embodiment, the touch sensing layer 406 could adopt the electrode configuration mentioned in the fourth embodiment. In brief, the plurality of first induction electrodes of the touch sensing layer 406 is alternately formed on the outer surface 364 of the upper cover 362, and the plurality of second induction electrodes of the touch sensing layer 406 is alternately formed on the inner surface 366 of the upper cover 362. The conductive traces 408 electrically connected to the first induction electrodes of the touch sensing layer 406 are formed on the outer surface 364 of the upper cover 362 corresponding to the decorative layer 20. The conductive traces 408 electrically connected to the second induction electrodes of the touch sensing layer 406 are formed on the inner surface 366 of the upper cover 362 corresponding to the decorative layer 20. As for the other related description for this embodiment, it could be reasoned according to the seventh embodiment and therefore omitted herein.

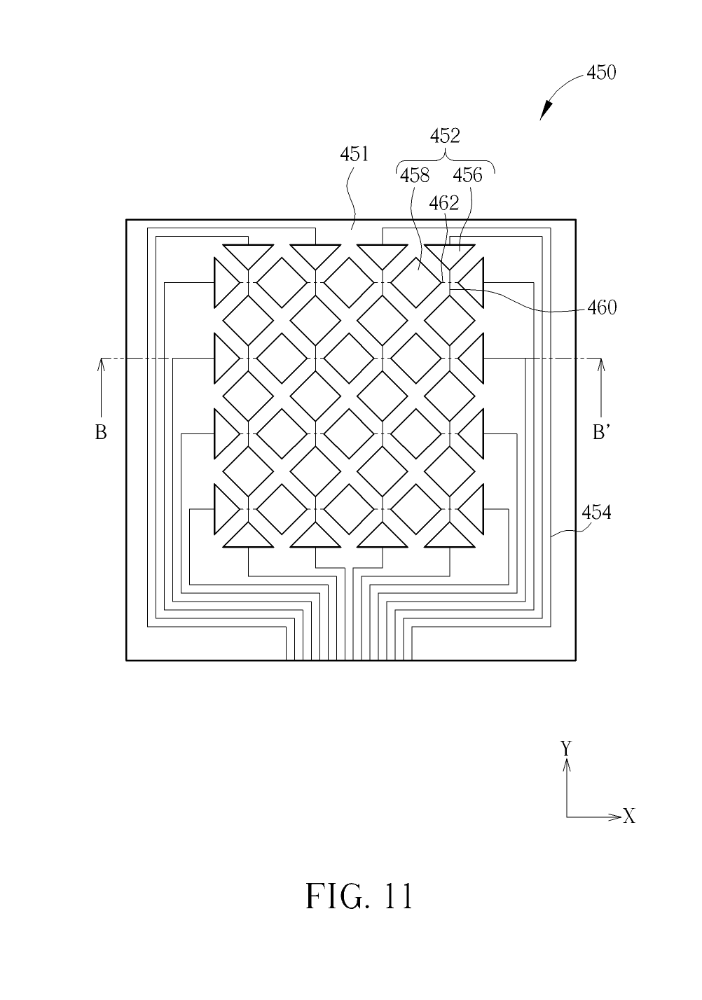

It should be mentioned that the touch sensing layer of the present invention could also adopt the design that the induction electrodes are in series connection respectively along the first axial direction and the second axial direction via wires. For example, please refer to FIG. 11, which is a top view of a touch sensing layer 450 according to a tenth embodiment of the present invention. As shown in FIG. 11, the touch layer structure 450 includes a flexible film 451, a touch sensing layer 452 and a plurality of conductive traces 454. The touch sensing layer 452 includes a plurality of block induction electrodes 456 in series connection along the first axial direction (i.e. the Y-axis direction in FIG. 11) and a plurality of block induction electrodes 458 in series connection along the second axial direction (i.e. the X-axis direction in FIG. 11). The block induction electrodes 456 are in series connection via first wires 460, and the block induction electrodes 458 are in series connection via second wires 462 wherein the conductive traces 454 are respectively connected with opposite ends of each series of the block induction electrodes 456 and the block induction electrodes 458 to reduce the impedance of the touch sensing layer 452 on the flexible film 451. As for the configuration of the touch layer structure 450 with the aforesaid transparent cover plate and the aforesaid decorative layer, it could be reasoned according to the aforesaid embodiments and therefore omitted herein.

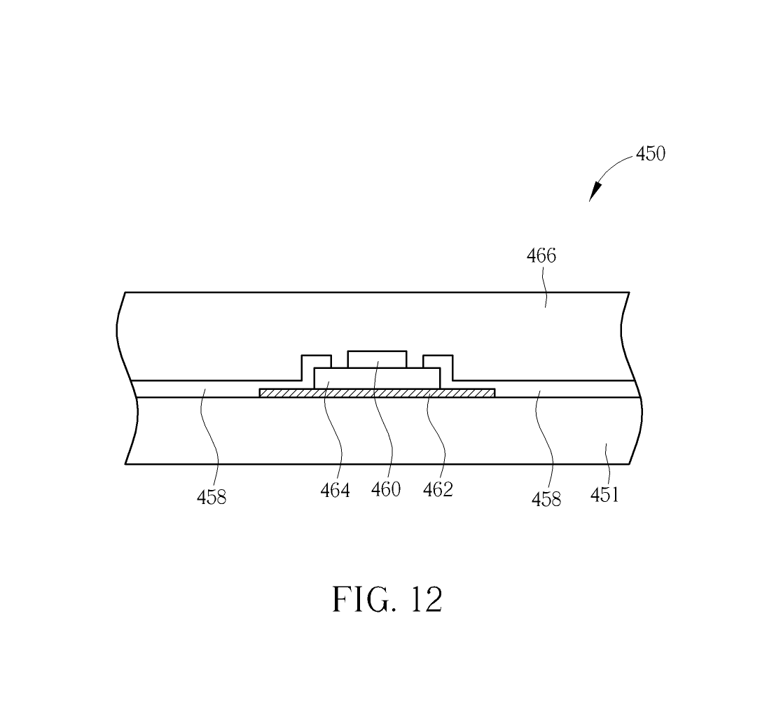

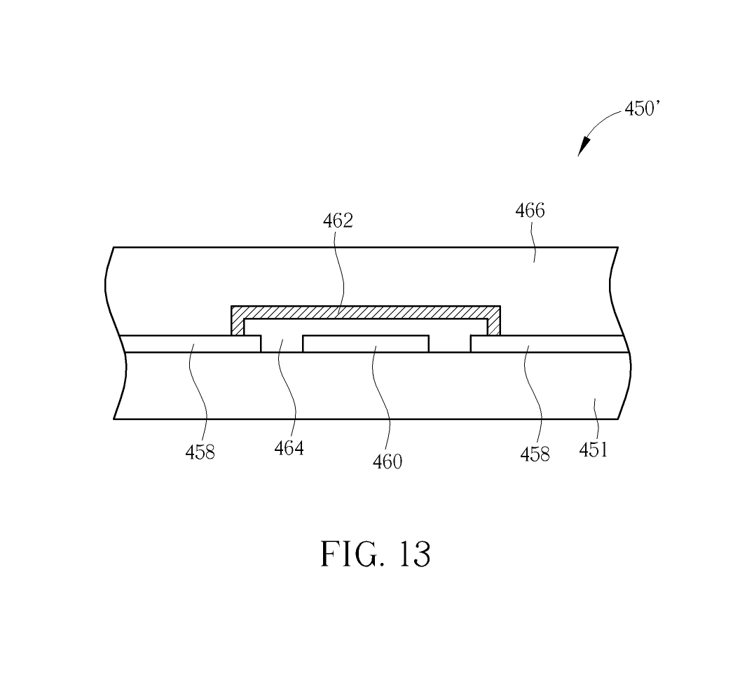

To be noted, for preventing the first wire 460 from contacting with the second wire 462, the touch sensing layer 452 could adopt the wire bridge design commonly applied to a conventional touch sensing layer. For example, please refer to FIG. 12, which is a partial sectional diagram of the touch sensing layer 450 in FIG. 11 along a sectional line B-B′. As shown in FIG. 12, the first wire 460 is located above the second wire 462, and the touch sensing layer 452 could further include an insulation layer 464 and a protection layer 466. The insulation layer 464 is formed between the first wire 460 and the second wire 462 for separating the first wire 460 from the second wire 462. The protection layer 466 is formed on the touch sensing layer 452 for protection. Furthermore, the touch sensing layer 452 could adopt the wire bridge design that the second wire 462 is located above the first wire 460 instead, and the related configuration could be as shown in FIG. 13, which is a partial sectional diagram of a touch layer structure 450′ according to an eleventh embodiment of the present invention. The related description for this embodiment could be reasoned according to the aforesaid embodiments and therefore omitted herein.

Compared with the prior art, the present invention adopts the design that the transparent cover plate has the side bending portion, the decorative layer is disposed on the side bending portion, and the conductive traces are disposed on the decorative layer, so that the touch display module could utilize the side bending portion to provide additional space for disposal of the conductive traces. In such a manner, the present invention could efficiently solve the prior art problem that space provided by the border area of the transparent cover plate is not enough to contain the numerous conductive traces. Furthermore, since disposal of the conductive traces does not occupy space of the planar surface portion of the transparent cover plate, the present invention could further narrow the border area of the touch display module so as to be advantageous to the narrow border design of the touch display module.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A touch panel comprising:
a transparent cover plate having a viewing area and at least one side bending portion;
a decorative layer formed at a position corresponding to the at least one side bending portion; and
a touch layer structure comprising:
a touch sensing layer disposed at a position at least corresponding to the viewing area; and
a plurality of conductive traces electrically connected to the touch sensing layer and disposed at a position corresponding to the decorative layer.

2. The touch panel of claim 1, wherein the touch layer structure further comprises a flexible film attached to the transparent cover plate, the touch sensing layer is formed on the flexible film at least corresponding to the viewing area, and the plurality of conductive traces is formed on the flexible film corresponding to the decorative layer.

3. The touch panel of claim 2, wherein the decorative layer is formed on the flexible film or the transparent cover plate.

4. The touch panel of claim 3, wherein the decorative layer is overlapped with the touch sensing layer.

5. The touch panel of claim 2, wherein the touch sensing layer comprises a plurality of first induction electrodes alternately formed on the flexible film and arranged along a first axial direction and a plurality of second induction electrodes formed adjacent the first induction electrodes and arranged along the first axial direction, one first induction electrode and corresponding second induction electrodes defines a touch sensing set for sensing capacitance effect variation therebetween, and the plurality of conductive traces are extended from the plurality of first induction electrodes and the plurality of second induction electrodes to the position corresponding to the decorative layer along the first axial direction.

6. The touch panel of claim 5, wherein the transparent cover plate has a planar surface portion and the plurality of conductive traces are extended from the position corresponding to the decorative layer to the position corresponding to the planar surface portion.

7. The touch panel of claim 2, wherein the touch sensing layer comprises a plurality of block induction electrodes alternately formed on the flexible film, and at least some of the plurality of conductive traces are extended from the plurality of block induction electrodes to the position corresponding to the decorative layer.

8. The touch panel of claim 7, wherein each of the block induction electrodes is in the form of triangle.

9. The touch panel of claim 7, wherein the transparent cover plate has a planar surface portion and the plurality of conductive traces are extended from the position corresponding to the decorative layer to the position corresponding to the planar surface portion.

10. The touch panel of claim 1, wherein the touch sensing layer is formed on an inner surface of the transparent cover plate, and at least some of the plurality of conductive traces are extended from the touch sensing layer to the position corresponding to the decorative layer.

11. The touch panel of claim 10, wherein the transparent cover plate has a planar surface portion and the plurality of conductive traces are extended from the position corresponding to the decorative layer to the position corresponding to the planar surface portion.

12. The touch panel of claim 1, wherein the touch layer structure further comprises a first flexible film and a second flexible film, the touch sensing layer comprises a plurality of first induction electrodes and a plurality of second induction electrodes, the plurality of first induction electrodes are alternately formed on the first flexible film along a first axial direction, the plurality of second induction electrodes are alternately formed on the second flexible film along a second axial direction, the conductive traces electrically connected to the plurality of first induction electrodes are formed on the first flexible film corresponding to the decorative layer, the conductive traces electrically connected to the plurality of second induction electrodes are formed on the second flexible film corresponding to the decorative layer, and the first flexible film is attached between the second flexible film and the transparent cover plate.

13. The touch panel of claim 12, wherein the decorative layer is formed on the first flexible film or the transparent cover plate.

14. The touch panel of claim 13, wherein the decorative layer is overlapped with the touch sensing layer.

15. The touch panel of claim 12, wherein the conductive traces electrically connected to the plurality of first induction electrodes and the conductive traces electrically connected to the plurality of second induction electrodes do not overlap or cross on the position corresponding to the decorative layer and the position corresponding to the planar surface portion.

16. The touch panel of claim 12, wherein the average width of each second induction electrode is wider than the average width of each first induction electrode.

17. The touch panel of claim 16, wherein the first induction electrodes are sensing electrodes and the second induction electrodes are driving electrodes; the impedance of each first induction electrode is smaller than that of each second induction electrode.

18. The touch panel of claim 16, wherein an average gap between the adjacent first induction electrodes is greater than the average width of each of the first induction electrodes, and an average gap between the adjacent second induction electrodes is smaller than the average width of each of the second induction electrodes.

19. The touch panel of claim 1, wherein the touch layer structure further comprises a flexible film attached to the transparent cover plate, a plurality of first induction electrodes and a plurality of second induction electrodes, the plurality of first induction electrodes are alternately formed on an outer surface of the flexible film along a first axial direction, the plurality of second induction electrodes are alternately formed on an inner surface of the flexible film along a second axial direction, the conductive traces electrically connected to the plurality of first induction electrodes are formed on the outer surface of the flexible film corresponding to the decorative layer, and the conductive traces electrically connected to the plurality of second induction electrodes are formed on the inner surface of the flexible film corresponding to the decorative layer.

20. The touch panel of claim 19, wherein the decorative layer is formed on the transparent cover plate or another flexible film which is arranged between the transparent cover plate and the flexible film.

21. The touch panel of claim 20, wherein the decorative layer is overlapped with the touch sensing layer.

22. The touch panel of claim 19, wherein the conductive traces electrically connected to the plurality of first induction electrodes and the conductive traces electrically connected to the plurality of second induction electrodes are not overlapped on the position corresponding to the decorative layer and the position corresponding to the planar surface portion.

23. The touch panel of claim 19, wherein the average width of each second induction electrode is wider than the average width of each first induction electrode.

24. The touch panel of claim 19, wherein a gap between the adjacent first induction electrodes is greater than a width of each of the first induction electrode, and a gap between the adjacent second induction electrodes is smaller than a width of each of the second induction electrode.

25. The touch panel of claim 1, wherein the touch panel further comprises a conductive shield layer and an insulation layer, the conductive shield layer is disposed on the decorative layer, and the insulation layer is disposed between the conductive shield layer and the plurality of conductive traces.

26. The touch panel of claim 1, wherein the decorative layer is made of metal material and the touch panel further comprises an insulation layer disposed between the decorative layer and the plurality of conductive traces.

27. The touch panel of claim 1, wherein the transparent cover plate comprises a planar surface portion or a curved surface portion corresponding the viewing area.

28. The touch panel of claim 1, wherein the touch sensing layer is patterned in the form of meshes.

29. The touch panel of claim 28, wherein the touch sensing layer is made of metal material.

30. The touch panel of claim 1, wherein the touch sensing layer is a composite layer comprising silver and indium tin oxide.

31. A touch display module comprising:
a host device;
a display panel disposed on the host device; and
a touch panel disposed on the display panel, the touch panel comprising:
a transparent cover plate having a viewing area and at least one side bending portion;
a decorative layer formed at a position corresponding to the at least one side bending portion; and
a touch layer structure comprising:
a touch sensing layer disposed at a position at least corresponding to the viewing area; and
a plurality of conductive traces electrically connected to the touch sensing layer and disposed at a position corresponding to the decorative layer.

32. The touch display module of claim 31, wherein the display panel comprises a bottom board and a display layer, the display layer is disposed on the bottom board, and the transparent cover plate contains the display layer cooperatively with the bottom board.

33. The touch display module of claim 31, wherein the touch layer structure further comprises a flexible film attached to the transparent cover plate, the touch sensing layer is formed on the flexible film at least corresponding to the viewing area, and the plurality of conductive traces is formed on the flexible film corresponding to the decorative layer.

34. The touch display module of claim 33, wherein the decorative layer is formed on the transparent cover plate or the flexible film.

35. The touch display module of claim 31, wherein the touch layer structure further comprises a first flexible film and a second flexible film, the touch sensing layer comprises a plurality of first induction electrodes and a plurality of second induction electrodes, the plurality of first induction electrodes are alternately formed on the first flexible film along a first axial direction, the plurality of second induction electrodes are alternately formed on the second flexible film along a second axial direction, the conductive traces electrically connected to the plurality of first induction electrodes are formed on the first flexible film corresponding to the decorative layer, the conductive traces electrically connected to the plurality of second induction electrodes are formed on the second flexible film corresponding to the decorative layer, and the first flexible film is attached between the second flexible film and the transparent cover plate.

36. The touch display module of claim 35, wherein the decorative layer is formed on the first flexible film or the transparent cover plate.

37. The touch display module of claim 31, wherein the touch layer structure further comprises a flexible film attached to the transparent cover plate, a plurality of first induction electrodes and a plurality of second induction electrodes, the plurality of first induction electrodes are alternately formed on an outer surface of the flexible film along a first axial direction, the plurality of second induction electrodes are alternately formed on an inner surface of the flexible film along a second axial direction, the conductive traces electrically connected to the plurality of first induction electrodes are formed on the outer surface of the flexible film corresponding to the decorative layer, and the conductive traces electrically connected to the plurality of second induction electrodes are formed on the inner surface of the flexible film corresponding to the decorative layer.

38. The touch display module of claim 37, wherein the decorative layer is formed on the transparent cover plate or another flexible film which is arranged between the transparent cover plate and the flexible film.

39. The touch display module of claim 38, wherein the decorative layer is overlapped with the touch sensing layer.

40. The touch display module of claim 31, wherein the display panel comprises an upper cover, a display layer, and a bottom board, the display layer is disposed on the bottom board, the upper cover packages the display layer cooperatively with the bottom board, the touch sensing layer is formed on the upper cover at least corresponding to the viewing area, the plurality of conductive traces is formed on the upper cover corresponding to the decorative layer, and the upper cover is attached to the transparent cover plate.

41. The touch display module of claim 31, wherein the display panel comprises an upper cover, a display layer, and a bottom board, the display layer is disposed on the bottom board, the upper cover packages the display layer cooperatively with the bottom board, the touch sensing layer comprises a plurality of first induction electrodes and a plurality of second induction electrodes, the plurality of first induction electrodes are alternately formed on an outer surface of the upper cover along a first axial direction, the plurality of second induction electrodes are alternately formed on an inner surface of the upper cover along a second axial direction, the conductive traces electrically connected to the plurality of first induction electrodes are formed on the outer surface of the upper cover corresponding to the decorative layer, and the conductive traces electrically connected to the plurality of second induction electrodes are formed on the inner surface of the upper cover corresponding to the decorative layer, and the upper cover is attached to an inner surface of the viewing area and the decorative layer.

42. The touch display module of claim 31, wherein the touch panel further comprises a conductive shield layer and an insulation layer, the conductive shield layer is disposed on the decorative layer, and the insulation layer is disposed between the conductive shield layer and the plurality of conductive traces.

43. The touch display module of claim 31, wherein the decorative layer is made of metal material and the touch panel further comprises an insulation layer disposed between the decorative layer and the plurality of conductive traces.

44. The touch display module of claim 31, wherein transparent cover plate comprises a planar surface portion or a curved surface portion corresponding the viewing area.
